(19) United States
(12) Patent Application Publication
(10) Pub. No.: US 2024/0198522 A1
(43) Pub. Date: Jun. 20, 2024

(54) METHOD FOR POSITIONING A FIRST COMPONENT RELATIVE TO A SECOND COMPONENT BY A ROBOTIC ARM SYSTEM

(71) Applicant: PERI SE, Weissenhorn (DE)

(72) Inventors: Alexander Schmid, Weissenhorn (DE); Wolfgang Strobel, Weissenhorn (DE)

(73) Assignee: PERI SE, Weissenhorn (DE)

(21) Appl. No.: 18/538,440

(22) Filed: Dec. 13, 2023

(30) Foreign Application Priority Data
Dec. 15, 2022 (DE) 10 2022 213 715.9

(51) Int. Cl. B25J 9/16

(52) U.S. Cl. CPC B25J 9/1664; B25J 9/1697

(57) ABSTRACT

A method for positioning a first component relative to a second component by a robotic arm system, comprising: providing at least a first robot arm arranged to hold and move a first component relative to a second component, wherein the robot arm is arranged to be moved coordinate-based; providing at least one laser scanning unit to detect a distance between the first component and the second component; picking up the first component by the first robot arm and moving the first component relative to the second component according to a coordinate-based calculated position; detecting a distance of the first component in its coordinate-based calculated position to the second component by the laser scanning unit; providing a position correction value based on the detected distance of the first component to the second component; moving at least one of the components to an end position based on the provided position correction value.

### FIELD OF THE INVENTION

The present invention relates to a method for positioning a first component relative to a second component by a robotic arm system. Further, the present invention relates to a robotic arm system for positioning a first component relative to a second component, a corresponding computer program element, a use and a steel frame.

### BACKGROUND

Robots are used in many different areas of industry, such as the automotive industry, the aerospace industry, the electrical industry, machine and plant construction, the metal industry, precision mechanics and other areas. In all these areas, compliance with predetermined dimensions and tolerances plays an important role when positioning two components in relation to each other. If tolerances are not met, a complete process step in production or the entire product may be void.

It has been found that there is a need to provide a method for positioning two components relative to each other.

It is an object of the present invention to provide a method for positioning a first component relative to a second component by a robotic arm system. Further, it is an object of the present invention to provide a robotic arm system for positioning a first component relative to a second component, a computer program element, a use and a steel frame.

These and other objects, which may be mentioned or recognized by the person skilled in the art when reading the following description, are solved by the subject matter of the independent claims. The dependent claims develop the core idea of the present invention in a particularly advantageous manner.

### SUMMARY OF THE INVENTION

A first aspect of the present invention relates to a method for positioning a first component relative to a second component by a robotic arm system, comprising: providing at least a first robotic arm configured to hold and move a first component relative to a second component, wherein the robotic arm is further configured to be moved based on coordinates; providing at least one laser scanning unit configured to detect a distance between the first component and the second component; picking up the first component by the first robot arm and moving the first component relative to the second component according to a coordinate-based calculated position; detecting a distance of the first component in its coordinate-based calculated position to the second component by the laser scanning unit; providing a position correction value based on the detected distance of the first component to the second component; moving at least one of the components to an end position based on the provided position correction value.

The method comprises positioning a first component relative to a second component. The first and second components are, for example, scaffolding components or formwork components. Other types of parts and/or components that need to be positioned relative to each other are possible. For example, body parts of a vehicle are also conceivable as components.

The robotic arm system comprises at least the first robot arm. The first robot arm is assigned to the first component. This means that the first robot arm is configured to hold or manipulate the first component. The robot arm is further configured to be moved relative to the second component based on coordinates. This means that the tool position of the robot arm is or can be described using a reference point and/or a reference plane, a so-called tool center point.

The first component is picked up and held by the first robot arm for positioning. The first component is then moved relative to the second component. The first component is moved in accordance with a position calculated based on coordinates. The coordinate-based calculated position is a predefined position in a coordinate system. In this position, a distance between the two components can be measured or detected using the laser scanning unit. The position correction value can be determined based on this detected distance. The first component can then be transferred or moved to the intended end position based on the position correction value provided or determined.

The advantage of the method according to the present invention is that the method can be applied flexibly to different types of components or objects. In other words, it is possible to precisely position an object with a robot independently of the position of a reference object. In other words, static offset values that are only valid for one specific position are no longer necessary. In this sense, the determined position correction values can be described as dynamic offset values. Consequently, it is possible, for example, to dispense with the fixed positioning of a component. Furthermore, the method described above improves the absolute accuracy of the robot with respect to a reference object.

In one embodiment, the at least one laser scanning unit is a 2D linear laser scanning unit. Other laser-based scanning units are also possible.

In one embodiment, at least the second component is arranged in a holding device. In other words, the second component is fixed in a holding device. As a result, the second component cannot change position during the method, so that only the first component is moved.

In one embodiment, the robotic arm system comprises at least a second robotic arm configured to hold and move the second component. This makes it possible to move and position the second component relative to the first component. This is particularly advantageous if the two components are intended to be subsequently joined together, for example.

In one embodiment, the first and/or second component are each moved to an end position by the first and/or second robot arm based on the provided position correction value.

In one embodiment, the robotic arm system comprises at least a third robotic arm configured to connect the first and second components in the end position. The term “joining” is to be understood broadly here. The joining can include, for example, welding, brazing, gluing, riveting or other types of joining not mentioned here.

Thus, it is possible that in one embodiment the method further comprises: Welding of the first and second components in the end position by the third robot arm. Welding can be carried out by spot welding or laser welding, for example. Other welding processes can also be used. The robotic arm system can also include more than two or three robot arms that perform the same or different functions.

The first component and the second component are not necessarily always the same components. For example, it is possible that a further third component is to be positioned on the first and second components that are already connected to each other and connected to them. In this case, the two already connected components form a new first component and the third component forms a new second component.

In one embodiment, the system comprises at least two laser scanning units. This can speed up the scanning process, as several scans can be performed simultaneously. The two laser scanning units can be arranged together on one robot arm, or each can be arranged on a separate robot arm. It is not impossible to use further additional laser scanning units.

In one embodiment, the at least two laser scanning units are arranged rigidly relative to each other. Furthermore, the two laser scanning units can be arranged linearly, orthogonally or radially to each other. The laser scanning units are each arranged according to their intended function. The alignment depends on the component to be scanned.

In one embodiment, the at least two laser scanning units are arranged in such a way that the emitted laser beams can be emitted at an angle to each other. This allows a larger surface to be scanned by the laser beams. The angle of the laser beams makes it possible to scan converging surfaces with one laser scanning unit each.

These scanned surfaces can then be evaluated, and an intersection line of these surfaces can be formed. This in turn has a positive effect on the measurement accuracy.

In one embodiment, the emitted laser beams cover an angle between 80° and 25°, preferably an angle between 60° and 35° and particularly preferably between 50° and 40°. It is advantageous if the framed angle of the emitted laser beams is adapted to the component to be scanned.

In one embodiment, the at least two laser scanning units are arranged so that they can move relative to one another. If the laser scanning units are arranged so that they can move relative to each other, the robotic arm system can be used flexibly. For example, in this embodiment, the robotic arm system can also be used for larger or more complex components without the need for conversion measures. The two laser scanning units can, for example, be configured to perform linear movements, radial movements or other movements in relation to each other.

In one embodiment, the at least one laser scanning unit or the at least two laser scanning units are arranged on a robot arm. This makes it possible to move the laser scanning units relative to the components to be scanned. In this way, the method can be accelerated.

In one embodiment, the at least one laser scanning unit or the at least two laser scanning units is/are arranged on a movable or freely movable unit provided in the robotic/robot arm system.

In one embodiment, the laser scanning unit is configured to determine two planes by scanning and to calculate their (virtual) intersection line. The procedure is as follows. Two planes are determined by laser scanning two surfaces of a component. An intersection line of the two planes is then calculated. The intersection line of these planes is used for the distance measurement. Components have corners or edges. These areas usually have a radius (corner radius). The laser beams of the laser scanning devices are reflected uncontrollably at these radii, so that accurate measurement is not possible. By determining the planes and calculating their (virtual) intersection line, this problem is avoided, and an accurate measurement of the distance is possible, even for components with corner radii. In addition, there is no need to provide the components as uniformly as possible, i.e., components with different corner radii can be used and the corresponding tolerances in the manufacture of the components can be correspondingly greater.

In one embodiment, the components are individual elements and/or already welded elements of a steel frame, in particular a steel frame for a Formwork element. Alternatively, other elements are conceivable, for example a body element, a scaffolding element or the like. The method is not limited to the embodiments disclosed herein but is suitable for various industrial applications. It is therefore possible that the material and geometry of the components may vary according to the application. For example, metals or plastics as well as angular or other profiles are conceivable.

Another aspect of the invention relates to a robot/robotic arm system for positioning a first component relative to a second component according to one of the preceding embodiments, comprising: at least a first robotic arm configured to hold and move a first component relative to a second component, wherein the robotic arm is further configured to be moved in a coordinate-based manner; at least one laser scanning unit configured to detect a distance between the first component and the second component.

A further aspect of the invention relates to a computer program element comprising instructions configured, when executed on computer devices of a computer environment, to perform the steps of the method according to any of the preceding embodiments.

A further aspect of the invention relates to a use of a robotic arm and/or at least one laser scanning unit in a method according to any of the preceding embodiments.

A further aspect of the present invention relates to a steel frame, in particular a steel frame for a Formwork element, manufactured according to a method according to one of the preceding embodiments.

### DESCRIPTION OF THE PREFERRED EMBODIMENTS

In the following, a detailed description of the figures is given, showing:

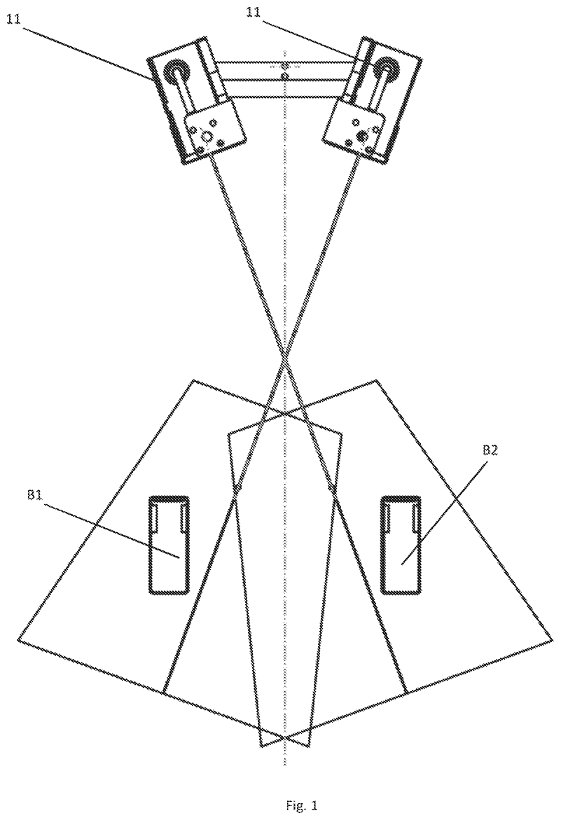

FIG. 1 a top view of an arrangement of two laser scanning units;

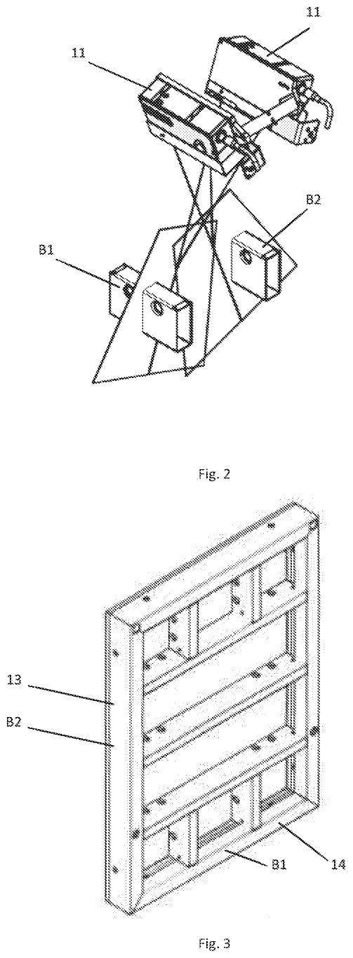

FIG. 2 a perspective view of two laser scanning units shown in FIG. 1;

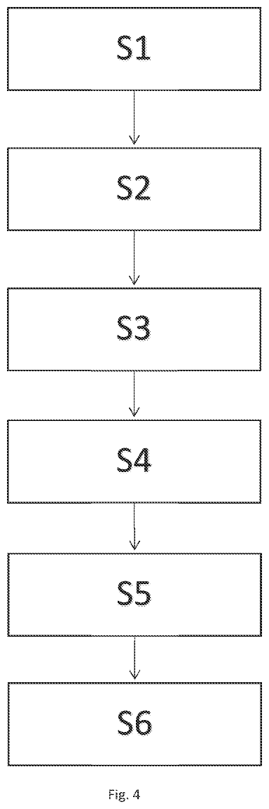

FIG. 3 a perspective view of an element (steel frame) manufactured by the described method;

FIG. 4 a flowchart of an embodiment of the method according to the present invention; and

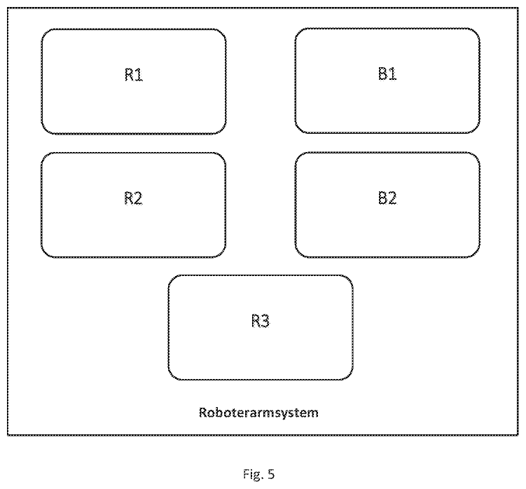

FIG. 5 a schematic view of an embodiment of a system.

### DETAILED DESCRIPTION

FIG. 1 and FIG. 2 each show an arrangement of two laser scanning units 11. The laser scanning units 11 are preferably arranged or attached to a robot arm R1 (cf. FIG. 5). The two laser scanning units 11 can be arranged rigidly or movably relative to each other.

The laser scanning units 11 are each aligned with a first component B1 and a second component B2. More precisely, the laser scanning units 11 are each aligned with the first or second component B1, B2 arranged diagonally opposite one another. The two components B1, B2 are each formed as a hollow profile. Other types of components or structural elements are possible.

The laser beams emitted by the two laser scanning units 11 each span an angle. For example, the emitted laser beams of the two laser scanning units 11 can each span an angle between 80° and 25°, preferably an angle between 60° and 35° and particularly preferably between 50° and 40°.

The angle of the emitted laser beams makes it possible to scan two surfaces of the first or second component. The laser scanning units are configured to determine an intersection line of these two planes by scanning two planes. The intersection line or the intersection point of these virtual planes or lines can be used for the distance measurement. The laser scanning units 11 can, for example, be designed as 2D laser scanning units or as 3D laser scanning units.

Components or structural elements have corners or edges. These areas usually have a radius (corner radius). The laser beams of the laser scanning units 11 are reflected uncontrollably at these radii, so that accurate measurement is not possible. By determining the planes and calculating the intersection line, this problem is avoided, so that a more accurate measurement of the distance is possible, and thus also a more accurate repositioning of the components in relation to each other.

FIG. 3 shows a component that was manufactured using a method described here. The component is a formwork element 12. In the manufactured state, the formwork element 12 comprises a frame and several inner struts. The frame comprises longitudinal elements 13 and transverse elements 14. For example, a transverse element 14 can be defined as the first component B1 and a longitudinal element 13 as the second component B2.

The second component B2 can, for example, be arranged in a holding device. Alternatively, it is conceivable that the second component B2 is held by a second robot arm R2. The two components B1 and B2 can then be positioned relative to one another according to the method described. The two components B1 and B2 can then be joined together. In one possible embodiment, a third robot arm R3, on which a welding device is arranged, can be used for this purpose.

FIG. 4 schematically illustrates a method for positioning a first component B1 relative to a second component B2 using a robotic arm system.

In a first step S1, at least a first robotic arm R1 is provided which is configured to hold the first component B1 and move it relative to the second component B2. The robot arm R1 is configured to be moved based on coordinates.

In a second step S2, at least one laser scanning unit 11 is provided, which is configured to detect a distance between the first component B1 and the second component B2.

In a third step S3, the first component B1 is picked up by the first robot arm R1 and moved relative to the second component B2 in accordance with a position calculated based on coordinates.

In a fourth step S4, a distance of the first component B1 in its coordinate-based calculated position to the second component B2 is detected by the laser scanning unit 11.

In a fifth step S5, a position correction value is provided based on the detected distance of the first component B1 to the second component B2.

In a sixth step S6, at least one of the components B1, B2 is moved to an end position based on the position correction value provided.

FIG. 5 shows a possible embodiment of a robotic arm system. The robotic arm system comprises the first robot arm R1, the second robot arm R2 and the third robot arm R3. The robot arms R1 and R2 are intended to pick up and position the first component B1 and the second component B2. The third robot arm is intended to connect the first component B1 to the second component B2. For this purpose, the third robot arm can comprise, for example, a welding device.

However, the present invention is not limited to the preceding preferred embodiments as long as it is encompassed by the subject matter of the claims. In addition, it is noted that the terms “comprising” and “comprising” do not exclude other elements or steps and the indefinite articles “one” or “a” do not exclude a plurality. Furthermore, it is noted that features or steps that have been described with reference to one of the above embodiments may also be used in combination with other features or steps of other embodiments described above.

### LIST OF REFERENCE SIGNS

11 Laser scanning unit
12 Formwork element
13 Longitudinal elements
14 Transverse element
R1 First robot arm
R2 Second robot arm
R3 Third robot arm
B1 First component
B2 Second component

1. A method for positioning a first component relative to a second component by a robotic arm system, comprising:
providing at least a first robot arm arranged to hold and move a first component relative to a second component, wherein the robot arm is further arranged to be moved coordinate-based;
providing at least one laser scanning unit adapted to detect a distance between the first component and the second component;
picking up the first component by the first robot arm and moving the first component relative to the second component according to a coordinate-based calculated position;
detecting a distance of the first component in its coordinate-based calculated position to the second component by the laser scanning unit;
providing a position correction value based on the detected distance of the first component to the second component; and
moving at least one of the components to an end position based on the provided position correction value.

2. The method according to claim 1, wherein at least the second component is arranged in a holding device.

3. The method according to claim 1, wherein the robotic arm system comprises at least a second robot arm arranged to hold and move the second component.

4. The method according to claim 1, wherein the first and/or second component are each moved to an end position by the first and/or second robot arm based on the provided position correction value.

5. The method according to claim 1, wherein the robotic arm system comprises at least a third robotic arm configured to connect the first and second components in the end position.

6. The method according to claim 1, wherein the system comprises at least two laser scanning units.

7. The method according to claim 6, wherein the at least two laser scanning units are rigidly arranged relative to each other.

8. The method according to claim 6, wherein the at least two laser scanning units are arranged such that the emitted laser beams can be emitted at an angle to each other.

9. The method according to claim 8, wherein the emitted laser beams enclose an angle between 80° and 25°, preferably an angle between 60° and 35° and particularly preferably between 50° and 40°.

10. The method according to claim 1, wherein the at least two laser scanning units are arranged movably relative to each other.

11. The method according to claim 6, wherein the laser scanning unit is configured to determine two planes by scanning and to calculate their intersection lines.

12. A robotic arm system for positioning a first component relative to a second component, comprising:
at least a first robot arm configured to hold and move the first component relative to the second component, wherein the robot arm is further configured to be moved coordinate-based;
at least one laser scanning unit configured to detect a distance between the first component and the second component.

13. A computer program element comprising instructions configured, when executed on computer devices of a computer environment, to execute the steps of the method according to claim 1 in a robotic arm system.

14. A use of a robotic arm and/or at least one laser scanning unit in a method according to claim 1 and/or in a robotic arm system.

15. A steel frame manufactured according to a method according to claim 1.

16. The steel frame of claim 15, wherein the steel frame is for a formwork element.
